(19) United States
(12) Patent Application Publication
(10) Pub. No.: US 2007/0000714 A1
(43) Pub. Date: Jan. 4, 2007

(54) Assembling structure of a frame of a cart for use by handicapped and elderly persons

(76) Inventor: Ching-Yao Lin, Meishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/168,517

(22) Filed: Jun. 29, 2005

(51) Int. Cl. B62D 21/00

(52) U.S. Cl. 180/311

(57) ABSTRACT

A cart frame includes front and rear parts, and a connecting device; the front part has a laid-down U-shaped of the receiving member, and a locating member secured to the receiving member; the locating member has a lengthways-extending room therein, which communicates with the inside of the receiving member; a spring and a pin are held in the room; the pin is passed into the spring at a thinner portion such that the spring normally makes the pin pass into the receiving member at the other end; a handle bar is passed through a slot of the locating member, and joined to the pin; the rear part has an engaging post thereon; thus, the front and rear parts will be firmly joined when the engaging post is passed into the receiving member, and the pin is biased to engage the engaging post by the spring, and when the connecting device is used.

### BACKGROUND OF THE INVENTION

1. Field of the invention

The present invention relates to a frame of a cart for use by handicapped and elderly persons, more particularly one, which includes a front part, and a rear part capable of being firmly joined to and separated from the front part with ease.

2. Brief Description of the Prior Art

The most common carts for use by handicapped and elderly persons are three-wheeled because three-wheeled carts have simpler structure and lower manufacturing cost than four-wheeled ones, and they are as easy to control as four-wheeled ones for the elderly. A common three-wheeled cart includes a front wheel, a pair of handlebars, two rear wheels, a motor connected to the rear wheels, and storage batteries electrically connected to the motor.

Because earlier carts are too big to be put into the trunks of cars, manufacturers make available easy-to-assemble carts, which can be separated into few parts for allowing transportation with cars, and which will be relatively steady with the various parts firmly joined together after assembled. For example, there is a kind of common conventional easy-to-assemble cart, which is equipped with a lever for changing the cart into a separable position with. However, the above-mentioned cart has a relatively complicated structure, and cannot be easily separated for transportation with a car, especially by the elderly and handicapped persons. And, most of the various models of conventional carts have the same disadvantages.

### SUMMARY OF THE INVENTION

It is a main object of the invention to provide an improvement on a frame of a cart to overcome the above-mentioned problem.

The frame of the present invention includes front and rear parts, and a connecting device. The front part has a laid-down U-shaped receiving member, and a locating member secured to the receiving member; the locating member has a lengthways-extending room therein, which communicates with the inside of the receiving member. A spring and a pin are held in the lengthways-extending room of the locating member. The pin is passed into the spring at a thinner portion such that the spring normally makes the pin pass into the receiving member at the other end. A pulling bar is passed through a slot of the locating member, and joined to the pin for linearly displacing the pin with. The rear part has an engaging post thereon. Thus, the front and rear parts will be firmly joined when the engaging post is passed into the receiving member, and the pin is moved to engage the engaging post by the spring, and when the connecting device is used.

### BRIEF DESCRIPTION OF THE DRAWINGS

The present invention will be better understood by referring to the accompanying drawings, wherein:

FIG. 1 is a perspective view of the cart according to the present invention,

FIG. 2 is a side view of the cart in the present invention,

FIG. 3 is a partial rear view of the cart in the present invention,

FIG. 4 is a partial top view of the cart in the present invention,

FIG. 5 is an exploded perspective view of the cart in assembly, and

FIG. 6 is a partial side view of the invention, with the transverse rod being held in the supporting elements of the connecting device.

### DETAILED DESCRIPTION OF THE PREFERRED EMBODIMENTS

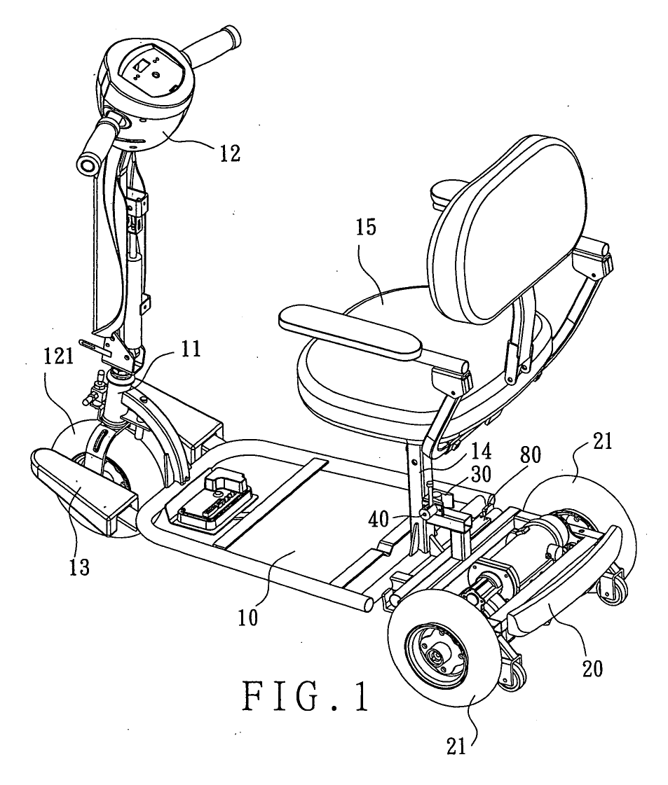

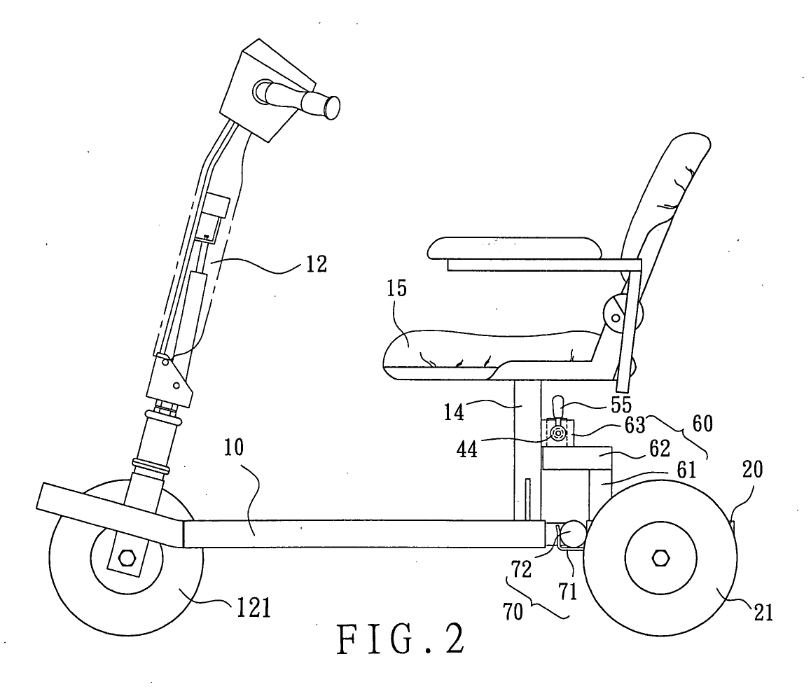

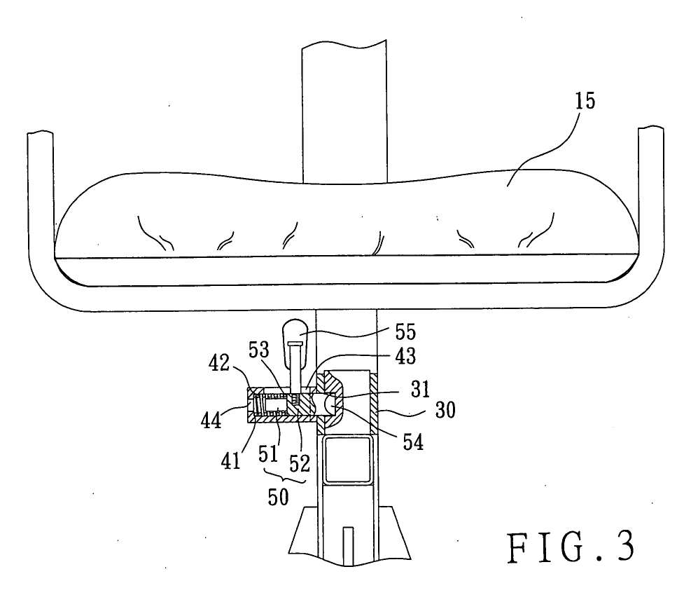

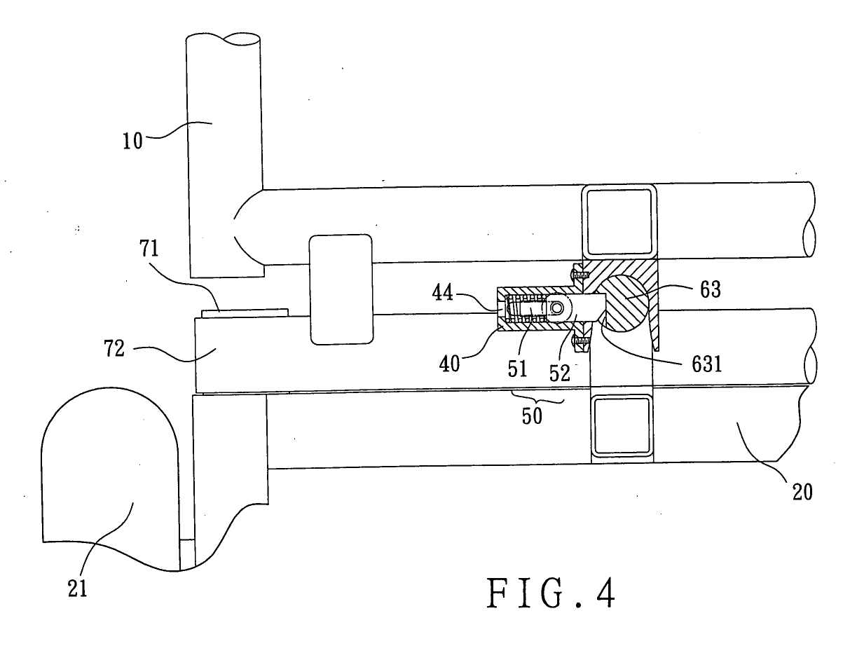

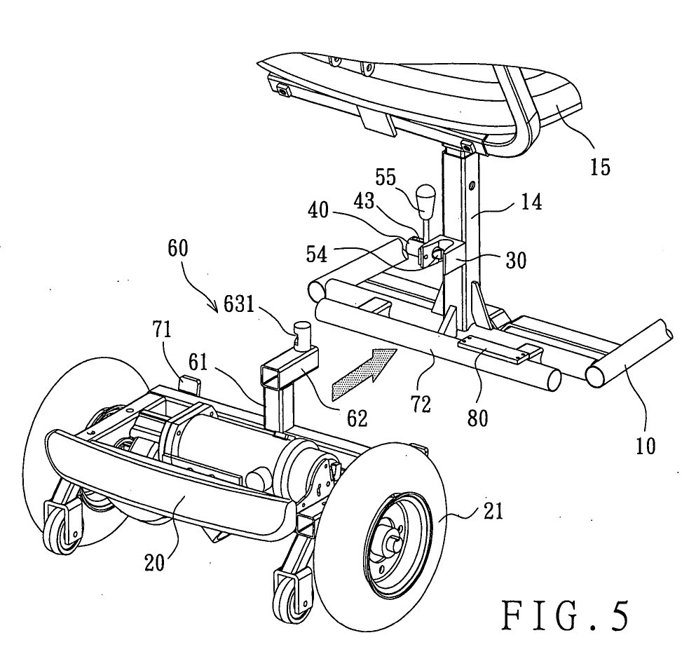

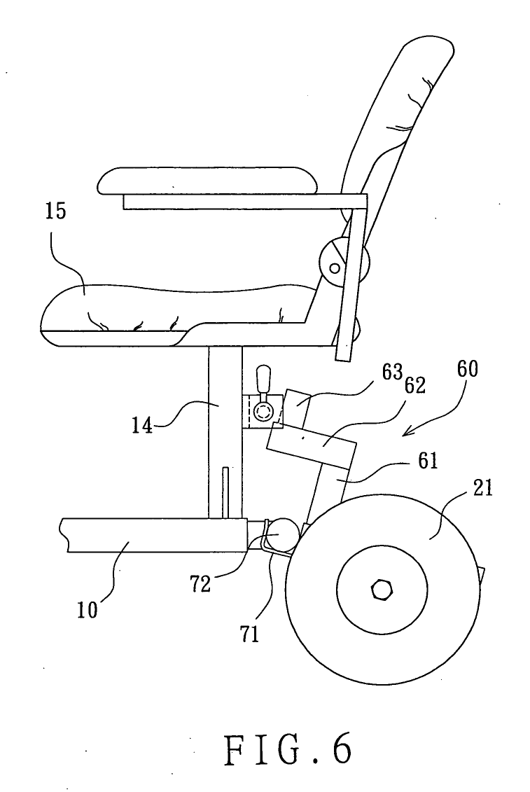

Referring to FIGS. 1 to 6, a preferred embodiment of a cart for use by handicapped and elderly persons in the present invention includes a frame, which consists of a front part 10, and a rear part 20.

The front part 10 of the frame has a first vertical supporting tube 11 secured on a front portion thereof, and two footrests 13 on two sides of the first vertical supporting tube 11. A cart head 12 is connected to the first vertical supporting tube 11, and pivoted onto a front wheel 121 by means of a fork-shaped member.

The front part 10 of the frame further has a second vertical supporting tube 14 secured on a rear portion thereof, and a U-shaped receiving member 30 secured on a rear side of the second vertical supporting tube 14, having a through hole 31 on a first lateral side. The second vertical supporting tube 14 is square and telescopic, and a seat 15 is joined to an upper end of the second vertical supporting tube 14. A locating member 40 being securely joined to the first lateral side of the U-shaped receiving member 30 has a lengthways-extending slot 43 on an upper side thereof and a lengthways-extending room 41 therein, which communicates with, and faces the through hole 31 of the U-shaped receiving member. In addition, the locating member 40 has a through hole 44 on an outward end thereof, which is farthest from the U-shaped receiving member 30.

A spring 42 and a pin 50 are held in the lengthways-extending room 41 of the locating member 40. The pin 50 has a first end portion 51, a second end portion 52 having a greater diameter than the first one 51, and a step-shaped portion 53 at the join between the first and the second end portions 51 and 52. The spring 42 is held in a portion of the lengthways-extending room 41 that is nearest to the outward end of the locating member 40. The pin 50 is passed into the spring 42 at the first end portion 51 such that the spring 42 normally makes the pin 50 pass through the through hole 31 formed on the U-shaped receiving member 30, and project into the holding space of the U-shaped receiving member 30 at the second end portion 52. The second end portion 52 of the pin 50 is formed with a sloping side 54 at a tail end. A pulling bar 55 is passed through the lengthways-extending slot 43 of the locating member 40, and securely joined to the second end portion 52 of the pin 50 such that the pin 50 can be linearly displaced by means of exerting force on the pulling bar 55. The through hole 44 of the locating member 40 allows the first end portion of the pin 50 to pass through it when the pin 50 is retreated from the holding space of the U-shaped receiving member 30.

The rear part 20 of the frame has two rear wheels 21 supported on two lateral sides thereof, and it has a connecting unit 60 secured on a rear portion thereof, which includes a vertical post 61 secured on the rear part 20, a horizontal rod 62, and an engaging post 63. The vertical post 61 is securely connected to the rear part 20, and the horizontal rod 62 is securely connected to an upper end of the vertical post 61 at a rear end thereof. The engaging post 63 is secured on a front portion of the horizontal rod 62 in a vertical position, and it has an engaging gap 631.

Furthermore, a connecting device 70 is provided for helping the front and the rear parts 10 and 20 of the frame firmly joined together. The connecting device 70 includes several supporting elements 71 secured to the front end of the rear part 20 of the frame, and a transverse rod 72 securely joined to the rear end of the front part 10 of the frame. The supporting elements 71 are substantially in the shape of an “L”, and each joined to the front end of the rear part 20 at a tail end of the horizontal lower portion thereof. In addition, above the transverse rod 72, a stopping element 80 is securely joined to the rear end of the front part 10. Alternatively, the supporting elements 71 can be securely joined to the rear end of the front part 10 of the frame, and both the transverse rod 72 and the stopping element 80 secured to the front end of the rear part 20.

To join the front and the rear parts 10 and 20 of the frame together, first transverse rod 80 is supported on the L-shaped supporting elements 71; thus, the rear part 20 is pivoted to the transverse rod 80, and can be angularly displaced relative to the front part 10. Then, the rear part 20 is pivoted close to the front part 10; thus, the engaging post 63 is passed into the U-shaped receiving member 30, and pressed against the sloping side 54 of the second end portion 52 of the pin 50 to retreat the pin 50 into the lengthways-extending room 41 of the locating member 40. Finally, the spring 42 makes the pin 50 project into the holding space of the U-shaped receiving member 30 so as to pass into the engaging gap 631 to engage the engaging post 63, preventing the engaging post 63 from moving out of the holding gap of the U-shaped receiving member 30. Consequently, the front and the rear parts 10 and 20 of the frame are firmly joined together.

And, the front part 10 can be easily separated from the rear part 20 after force is exerted on the pulling bar 55 to retreat the pin 50 into the lengthways-extending room 41 of the locating member 40.

From the above description, it can be easily seen that the cart has the following advantages:

1. The front and the rear parts of the frame can be joined together and separated easily; therefore, the cart is convenient to use.

2. The frame has a relatively simple structure and is light in weight, and it takes less time and money to manufacture the cart of the present invention. Therefore, the cart is suitable for mass production.

What is claimed is:

1. An assembling structure of a frame of a cart for use by handicapped and elderly persons, comprising
a frame having a front part and a rear part;
a first vertical supporting tube secured on a front portion of the front part of the frame for connection with a cart head; and
a connecting device; the connecting device including a transverse rod secured to a rear end of the front part of the frame, and a plurality of supporting elements secured to a front end of the rear part of the frame;
the front part of the frame further including:
(a) a second vertical supporting tube secured on a rear portion thereof;
(b) a receiving member secured on a rear side of the second vertical supporting tube, having a holding space therein; the receiving member having a through hole on a first lateral side thereof, which communicates with the holding space; the second vertical supporting tube having a seat joined to an upper end thereof;
(c) a locating member securely joined to the first lateral side of the receiving member; the locating member having a lengthways-extending slot on an upper side thereof; the locating member having a lengthways-extending room therein, which communicates with and faces the through hole of the receiving member;
(d) a spring held in a portion of the lengthways-extending room that is nearest to an outward end of the locating member, and farthest from the holding space of the receiving member;
(e) a pin held in the lengthways-extending room of the locating member; the pin having a first end portion, and a second end portion having a greater diameter than the first one; the pin being passed into the spring at the first end portion thereof such that the spring normally makes the pin pass through the through hole of the receiving member, and project into the holding space at the second end portion;
(f) a pulling bar; the pulling bar being passed through the lengthways-extending slot of the locating member, and securely joined to the second end portion of the pin such that the pin will be linearly displaced when force is exerted on the pulling bar;
the rear part of the frame having a connecting unit secured on a rear portion thereof; the connecting unit including:
(a) a vertical post secured on the rear portion of the rear part;
(b) a horizontal rod securely connected to an upper end of the vertical post at a rear end thereof;
(c) an engaging post secured on a front portion of the horizontal rod;
whereby the front and rear parts of the frame will be joined together when the engaging post is passed into the holding space of the receiving member, and the pin is moved to pass into the holding space and engage the engaging post by means of the spring, and when the transverse rod of the connecting device is supported on the supporting elements of the connecting device.

2. The cart as claimed in claim 1, wherein the engaging post of the connecting unit of the rear frame part has an engaging gap thereon for the second end portion of the pin to engage.

3. The cart as claimed in claim 1, wherein a stopping element is secured on a rear end of the front part of the frame.

4. The cart as claimed in claim 1, wherein the receiving member has a U-shaped holding space.

5. The cart as claimed in claim 1, wherein the second end portion of the pin is formed with a sloping side at a tail end thereof.

6. The cart as claimed in claim 1, wherein the locating member has a through hole on an outward end thereof, which is farthest from the holding space of the receiving member, for allowing the first end portion of the pin to pass through.

7. The cart as claimed in claim 1, wherein the transverse rod of the connecting device is secured to a front end of the rear part of the frame instead, and the supporting elements of the connecting device, which are used to hold the transverse rod in position, are secured to a rear end of the front part of the frame instead.

8. The cart as claimed in claim 1, wherein a stopping element is secured on a front end of the rear frame part.
